(19) United States
(12) Patent Application Publication
(10) Pub. No.: US 2013/0216749 A1
(43) Pub. Date: Aug. 22, 2013

(54) INFUSION SOLUTION BAG AND EXTERIOR FILM

(71) Applicant: FUJIFILM Corporation, (US)

(72) Inventor: Satoshi AIBA, Kanagawa (JP)

(73) Assignee: FUJIFILM Corporation, Tokyo (JP)

(21) Appl. No.: 13/853,478

(22) Filed: Mar. 29, 2013

Related U.S. Application Data
(63) Continuation-in-part of application No. PCT/JP2011/072646, filed on Sep. 30, 2011.

(30) Foreign Application Priority Data
Oct. 1, 2010 (JP) 2010-224188

(51) Int. Cl. B32B 27/08; A61J 1/10

(52) U.S. Cl. CPC B32B 27/08; A61J 1/10
USPC 428/36.6; 428/523; 156/60

(57) ABSTRACT

An infusion solution bag includes a bag made of a resin film including polyethylene and/or polypropylene, and a barrier layer provided on at least one surface of the bag, wherein the barrier layer has a structure in which a first organic layer, an inorganic layer and a second organic layer mutually adjoin in this order.

### BACKGROUND OF THE INVENTION

1. Field of the Invention

The present invention relates to an infusion solution bag. The invention relates particularly to an infusion solution bag for storing liquid and the like, which are administered beneath skin, into a blood vessel, an abdominal cavity and the like. In addition, the invention relates to an exterior film for protecting an outside of the infusion solution bag or the like.

2. Description of the Related Art

Thus far, a variety of studies have been made regarding infusion solution bags. JP2003-230618A describes that an outside of a bag, into which a medicine is fed, is protected using an oxygen-impermeable cover sheet. In addition, JP1998-201818A (JP-H10-201818A) describes that an outside of a bag, into which a medicine is fed, is protected using a plastic film laminated material having an oxygen-absorbing resin layer on an inside of a gas barrier layer.

### SUMMARY OF THE INVENTION

Since an oxygen-absorbing layer is provided in a sheet that protects the bag, into which a medicine is fed, as described above, it is possible to prevent oxygen from intruding into the bag. However, in general, the oxygen-absorbing resin layer cannot sufficiently prevent an intrusion of water vapor. Furthermore, as a result of studies, the present inventors found that, when an oxygen-absorbing resin layer is provided, there is a case in which moisture intrudes through a cross-section of the oxygen-absorbing resin layer. That is, an infusion solution bag that can prevent the intrusion of both oxygen and water vapor has not yet been obtained. Particularly, an infusion solution bag that can prevent the intrusion of both oxygen and water vapor cannot be obtained without providing an oxygen-absorbing resin layer.

The invention has been made to solve the above problem, and an object of the invention is to provide an infusion solution bag that can prevent the intrusion of both oxygen and water vapor.

As a result of thorough studies carried out based on the above circumstance, the inventors found that, when a barrier layer including a first organic layer, an inorganic layer and a second organic layer on a surface of a bag made of a resin film including polyethylene and/or polypropylene, in which the first organic layer, the inorganic layer and the second organic layer mutually adjoin in this order, is provided, an infusion solution bag that can prevent the intrusion of both oxygen and water vapor can be obtained without providing an oxygen-absorbing resin layer, and completed the invention.

An infusion solution bag of the invention, which can solve the problems of the invention, includes a bag made of a resin film including polyethylene and/or polypropylene and a barrier layer provided on at least one surface of the bag, wherein the barrier layer has a structure in which a first organic layer, an inorganic layer and a second organic layer mutually adjoin in this order.

In a preferable embodiment of the infusion solution layer of the invention, a gas barrier film is attached to an outside of the bag made of the resin film through at least an adhesion layer, the gas barrier film has a plastic film and the barrier layer, the barrier layer is provided closer to the bag made of the resin film than to the plastic film, or the resin film including polyethylene and/or polypropylene and the barrier layer are provided in this order on an outside of the bag made of the resin film.

In addition, in another preferable embodiment of the infusion solution bag of the invention, the bag made of the resin film is a bag formed by joining two resin films including polyethylene and/or polypropylene or a bag formed by folding and joining a resin film including polyethylene and/or polypropylene, the barrier layers are provided on both surfaces of the bag made of the resin film, the first organic layer and the second organic layer are formed of the same material, and at least one of the first organic layer and the second organic layer is a layer formed by curing a polymerizable composition including a (meth)acrylate-based compound.

Furthermore, in another preferable embodiment of the infusion solution bag of the invention, a thickness of at least one of the first organic layer and the second organic layer is 0.1 μm to 10 μm, a total thickness of layers provided on an outside of the resin bag is 20 μm to 200 μm, a surface of the infusion solution bag, on which the barrier layer is provided, is transparent, and an oxygen-absorbing resin layer is not included between the outside of the bag made of the resin film and the barrier layer.

In addition, furthermore, in another preferable embodiment of the infusion solution bag of the invention, the resin film including polyethylene and/or polypropylene, the adhesion layer and the gas barrier film are provided in this order on the outside of the bag made of the resin film in a mutually adjoining fashion, the oxygen-absorbing resin layer is included between the outside of the bag made of the resin film and the barrier layer, the resin layer including polyethylene and/or polypropylene, the adhesion layer, the oxygen-absorbing resin layer, the adhesion layer and the gas barrier film are provided in this order on the outside of the bag made of the resin film in a mutually adjoining fashion, and the adhesion layer includes an epoxy resin-based adhesive or a polyurethane-based adhesive.

Another preferable embodiment of the infusion solution bag of the invention is a duplex infusion solution bag.

The invention includes an exterior film having the resin film including polyethylene and/or polypropylene, the oxygen-absorbing resin layer and the barrier layer in this order.

The invention includes an exterior film having the resin film including polyethylene and/or polypropylene, the oxygen-absorbing resin layer provided on the resin film through the adhesion layer, and the barrier layer provided on the oxygen-absorbing resin layer through the adhesion layer in this order.

A preferable embodiment of the exterior film of the invention has the resin film including polyethylene and/or polypropylene, the adhesion layer and the barrier layer in this order.

The invention also includes a method for manufacturing an infusion solution bag including attaching the resin film side of a laminate having the resin film including polyethylene and/or polypropylene and the gas barrier film to the bag made of the resin film using a thermal sealing method.

According to the invention, it became possible to provide an infusion solution bag that can prevent the intrusion of both oxygen and water vapor.

### BRIEF DESCRIPTION OF THE DRAWINGS

FIG. 1 is a schematic view illustrating an example of a configuration of an infusion solution bag of the invention.

FIG. 2 is a schematic view illustrating an example of a configuration of an exterior film of the invention.

### DESCRIPTION OF THE PREFERRED EMBODIMENTS

Hereinafter, the contents of the invention will be described in detail. Further, in the present specification, “to” in a numeric range has a meaning of including numeric values described before and after the “to” as the lower limit value and the upper limit value. In the specification, “groups” in an alkyl group and the like may or may not have a substituent unless particularly otherwise described. Furthermore, in the case of group having a limited number of carbon atoms, the number of carbon atoms refers to the number of carbon atoms included in the substituent.

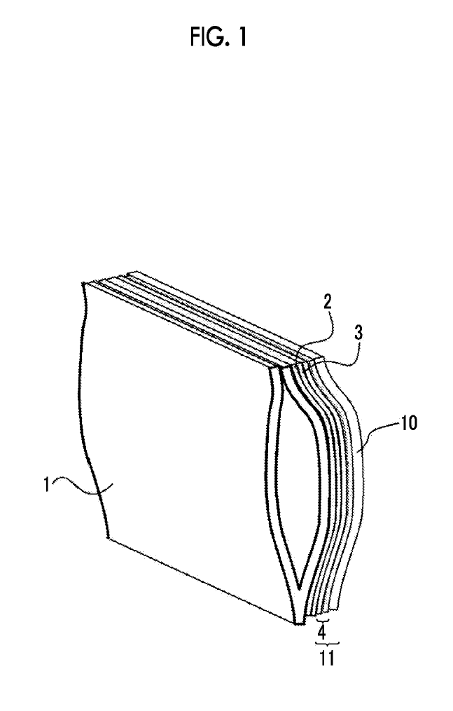

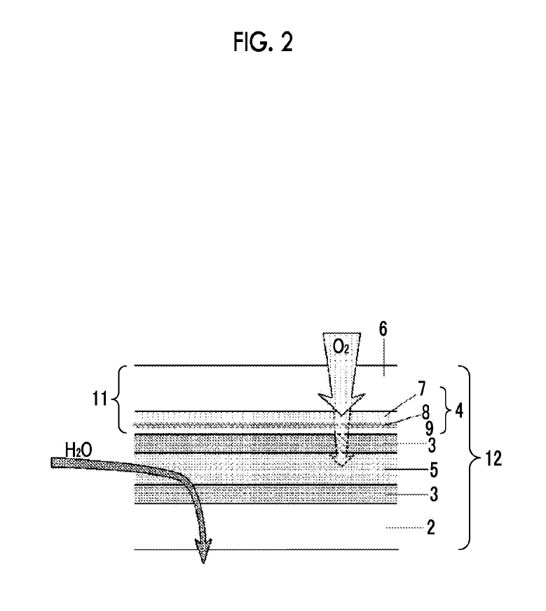

An infusion solution bag of the invention has a bag made of a resin film including polyethylene and/or polypropylene (hereinafter referred to simply as “resin film”) and a barrier layer provided on at least one surface of the bag. The configuration of the barrier layer used in the invention is not particularly limited, and the barrier layer may be configured of, for example, at least one layer selected from a group consisting of organic layers, inorganic layers and other configuration layers (the details will be described below). In a case in which the barrier layer is configured of two or more layers selected from the above group, the order of laminating the respective layers is not particularly limited. In the invention, the barrier layer preferably has a structure in which a first organic layer, an inorganic layer and a second organic layer mutually adjoin in this order. Hereinafter, the infusion solution bag of the invention will be described in detail according to FIGS. 1 and 2. Further, it is needless to say that the infusion solution bag of the invention is not limited to the configuration illustrated in FIG. 1 or 2.

FIG. 1 is a schematic view illustrating an example of the configuration of the infusion solution bag of the invention, in which an exterior film made of a resin film 2 including polyethylene and/or polypropylene, an adhesion layer 3 and a gas barrier film 11 sequentially from the bag is provided on at least one surface of the bag 1 made of a resin film.

Here, the gas barrier film 11 has a barrier layer 4 having a structure, in which a first organic layer, an inorganic layer and a second organic layer mutually adjoin in this order, and a plastic film 10, and the barrier layer 4 is provided closer to the adhesion layer 3. The gas barrier film 11 is attached to the resin film 2 through the adhesion layer 3. In addition, the resin film 2 is fused with the bag 1 made of the resin film using a thermal sealing method or the like.

In the present embodiment, the bag 1 made of the resin film is made up of two film surfaces, but may be made up of three or more film surfaces within the scope of the purport of the invention.

In the embodiment, separately from the bag 1 made of the resin film, the resin film 2 is provided; however, in the invention, the resin film 2 is not an essential component, and the gas barrier film 11 may be attached to the bag 1 made of the resin film through the adhesion layer 3. Furthermore, the barrier layer 4 is directly provided on the surface of the bag 1 made of the resin film. In addition, there can be a case in which the resin film 2 is thermally fused and integrated with the bag 1 made of the resin film (the interface between the resin film 2 and the bag 1 is lost). Particularly, the embodiment has an assumption that there is a case in which the resin film 2 uses the same resin film as the bag 1 made of the resin film.

In addition, the resin film 2 and the bag 1 made of the resin film does not necessarily need to be joined through fusion, and may be joined through the adhesion layer.

In the embodiment, an exterior film is provided on only one surface of the bag made of the resin film, but may be provided on both surfaces. In the invention, since a transparent exterior film can be used, even when the exterior film is provided on both surfaces, the center can be easily confirmed.

FIG. 2 illustrates a second embodiment of the infusion solution bag of the invention, in which an exterior film 12 is joined to the bag 1 made of the resin film on the bottom side (resin film 2), and is used.

In the second embodiment illustrated in FIG. 2, an oxygen-absorbing resin layer 5 is included between the outside of a bag 2 made of a resin film and the gas barrier film 11. The above configuration enables the more effective suppression of the entrance of oxygen. Here, the oxygen-absorbing resin layer 5 is generally attached to the resin film 2 using the adhesion layer 3, but may be attached using other means. Meanwhile, in a case in which the barrier layer 4 and the oxygen-absorbing resin layer 5 are attached using the adhesion layer 3, the barrier layer 3 is not limited to the structure illustrated in FIG. 2, in which the first organic layer, the inorganic layer and the second organic layer mutually adjoin in this order. For example, the barrier layer 3 may be configured of at least one layer selected from a group consisting of organic layers, inorganic layers, and other configuration layers described below. In addition, in a case in which the barrier layer 3 is configured using two or more layers selected from the above group, the order of laminating the respective layers is also not particularly limited.

In addition, the locations of the gas barrier film 11 and the oxygen-absorbing resin layer 5 may be switched. That is, the bag 2 made of the resin film, the gas barrier film 11 and the oxygen-absorbing resin layer 5 may be laminated in this order. The bag, the gas barrier film and the oxygen-absorbing resin layer preferably adjoin mutually through the adhesion layers.

In the present embodiment, the intrusion of oxygen can be more effectively suppressed, but there is a case in which water vapor intrudes through the cross-section between the oxygen-absorbing resin layer 5 and the adjacent adhesion layer 3. Therefore, in a case in which the suppression of the intrusion of water vapor more matters, an embodiment, in which the oxygen-absorbing resin layer 5 is not provided, is preferable. Particularly, in the invention, the intrusion of oxygen can be suppressed using the barrier layer 4 even when the oxygen-absorbing resin layer 5 is not provided.

The Resin Film Including Polyethylene and/or Polypropylene

The resin film including polyethylene and/or polypropylene, which is used as the resin film that configures the bag of the invention or as the resin film provided on the outside of the bag, is a resin film including polyethylene and/or polypropylene as a main component. The resin film may include other resins, but generally includes 99 mass % of polyethylene and/or polypropylene. A variety of additives may be added to the resin film, but the resin film is preferably transparent. Particularly, the resin film on the side provided with the barrier layer is preferably transparent. Here, the resin film being transparent refers to a fact that the light permeability is 50% or more, and preferably 70% or more.

In the invention, the resin film that configures the bag made of the resin film and the resin film joined to the bag made of the resin film may be made of different materials or the same material.

The Bag Made of the Resin Film

The bag made of the resin film is configured of a resin film, and other detailed requirements of the resin film can be appropriately determined as long as the resin film has a shape that can store an infusion solution. Examples of the bag made of the resin film include a bag formed by joining two resin films and a bag formed by folding and joining one resin film.

In general, the end portion of the resin film is fully joined except for a liquid discharging opening. In addition, examples of the joining method include a thermal sealing method, attaching using an adhesive and a sealing method in which a sealing member, such as metal, is used.

In the case of the bag formed by joining two resin films, the two resin films may be films made of different materials or films made of the same material. In the case of the films made of the same material, the films can be easily attached when the thermal sealing method is used for attaching. Needless to say, in a case in which two resin films are attached using an adhesive or the like, not only the resin films made of the same material but also the resin films made of different materials can be used.

The Gas Barrier Film

The gas barrier film used in the invention has a plastic film 6 and the barrier layer 4 as illustrated in FIG. 2. In addition, the barrier layer 4 includes a structure in which at least a first organic layer 7, an inorganic layer 8 and a second organic layer 9 mutually adjoin in this order. The barrier layer in the invention may further have one or more inorganic layers. In addition, one or more organic layers and inorganic layers may be further laminated alternately.

Other configuration layers may be provided between the plastic film and the barrier layer, on the outermost surface of the barrier layer and on a surface on the opposite side to the side of the plastic film on which the barrier layer is provided. The other configuration layers are described in detail in paragraphs [0036] to [0038] in JP2006-289627A. In addition, the other configuration layers are exemplified by a mat agent layer, a protective layer, a solvent-resistant layer, an antistatic layer, a flattening layer, an adhesion improving layer, a light shielding layer, an antireflection layer, a hard coat layer, a stress relieving layer, an antifouling layer, an anti-contamination layer, a layer to be printed, an easy welding layer and the like.

(Plastic Film)

The plastic film described in paragraphs [0009] to [0012] in JP2009-172993A can be preferably employed as the plastic film.

The thickness of the plastic film is preferably 5 μm to 150 μm, and more preferably 10 μm to 100 μm.

(The Organic Layer)

The barrier layer in the invention has the first organic layer and the second organic layer. The first organic layer plays a role of an undercoat layer that serves as the foundation of the inorganic layer, and thus has a different function from that of the second organic layer. However, in the invention, the first organic layer and the second organic layer can be formed of the same material, and are preferably formed of the same material. The above configuration has a tendency of improving the production efficiency.

The organic layer in the invention is preferably an organic layer including an organic polymer as a main component. Here, the main component refers to a fact that the primary component of the components that configure the organic layer is an organic polymer, and, in general, refers to a fact that 80 mass % or more of the components that configure the organic layer is the organic polymer.

Examples of the organic polymer include thermoplastic resins, such as polyester, acrylic resins, methacrylic resins, methacrylate-maleate copolymers, polystyrene, transparent fluororesin, polyimide, polyimide fluoride, polyamide, polyamide-imide, polyether imide, cellulose acrylate, polyurethane, polyether ether ketone, polycarbonate, alicyclic polyolefin, polyarylate, polyether sulfone, polysulfone, fluorine ring-denatured polycarbonate, alicyclic denatured polycarbonate, fluorine ring-denatured polyester and acryloyl compounds; organic silicon polymers, such as polysiloxane; and the like.

The organic layer in the invention is preferably formed by curing a polymerizable composition including a polymerizable compound.

(The Polymerizable Compound)

The polymerizable compound is preferably a radical polymerizable compound and/or a cationic polymerizable compound having an ether group, and more preferably a compound having an ethylenic unsaturated bond at the terminal or the side chain and/or a compound having epoxy or oxetane at the terminal or the side chain. Among the above, the compound having an ethylenic unsaturated bond at the terminal or the side chain is preferable. Examples of the compound having an ethylenic saturated bond at the terminal or the side chain include (meth)acrylate-based compounds, acrylamide-based compounds, styrene-based compounds, maleic acid anhydrides and the like, (meth)acrylate-based compounds and/or styrene-based compounds are preferable, and (meth)acrylate-based compounds are more preferable.

The (meth)acrylate-based compound is preferably (meth)acrylate, urethane(meth)acrylate or polyester(meth)acrylate, epoxy(meth)acrylate, or the like.

The styrene-based compound is preferably styrene, α-methyl styrene, 4-methyl styrene, divinylbenzene, 4-hydroxy styrene, 4-carboxy styrene, or the like.

Hereinafter, specific examples of the (meth)acrylate-based compounds preferably used in the invention will be illustrated, but the invention is not limited thereto.

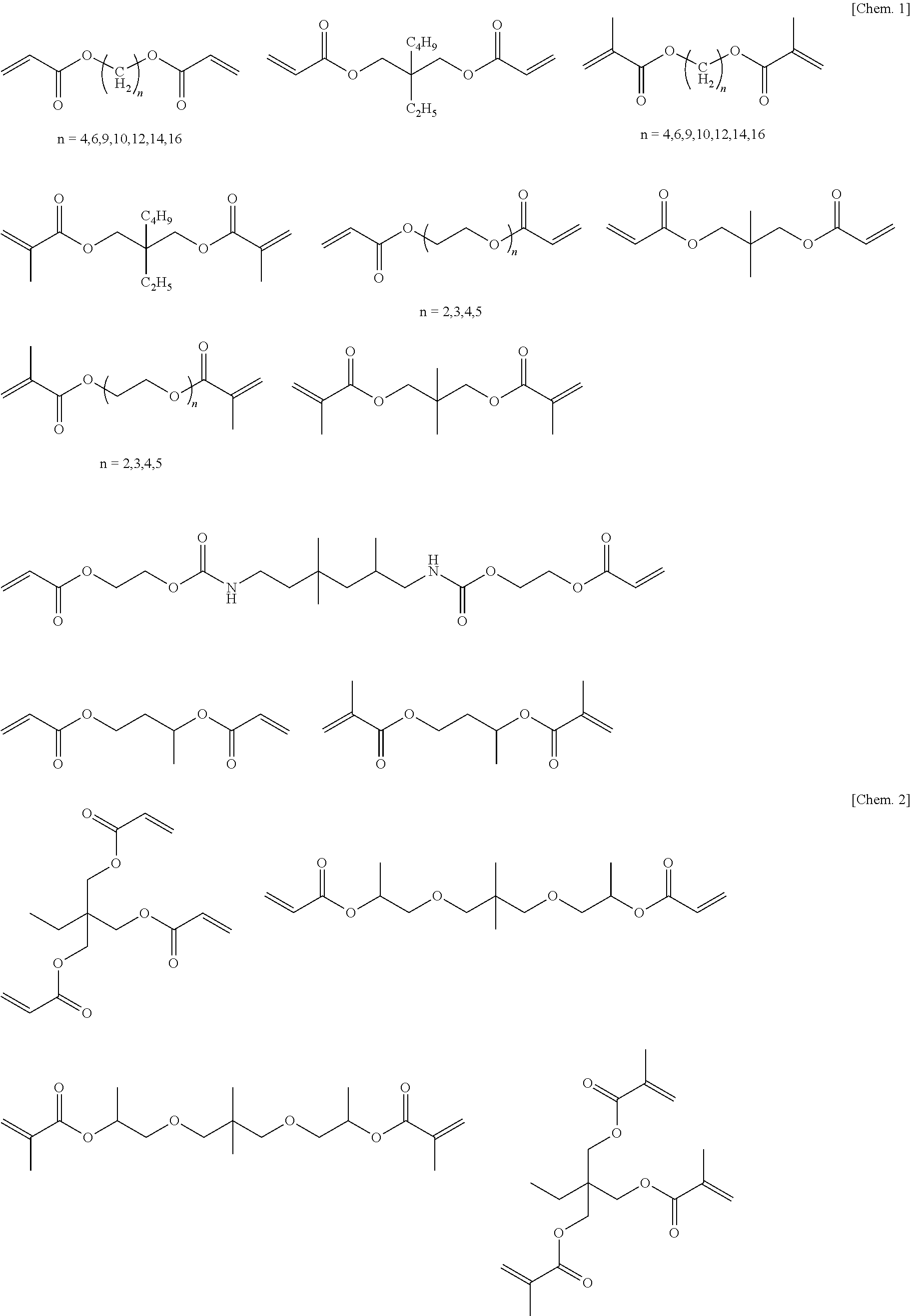

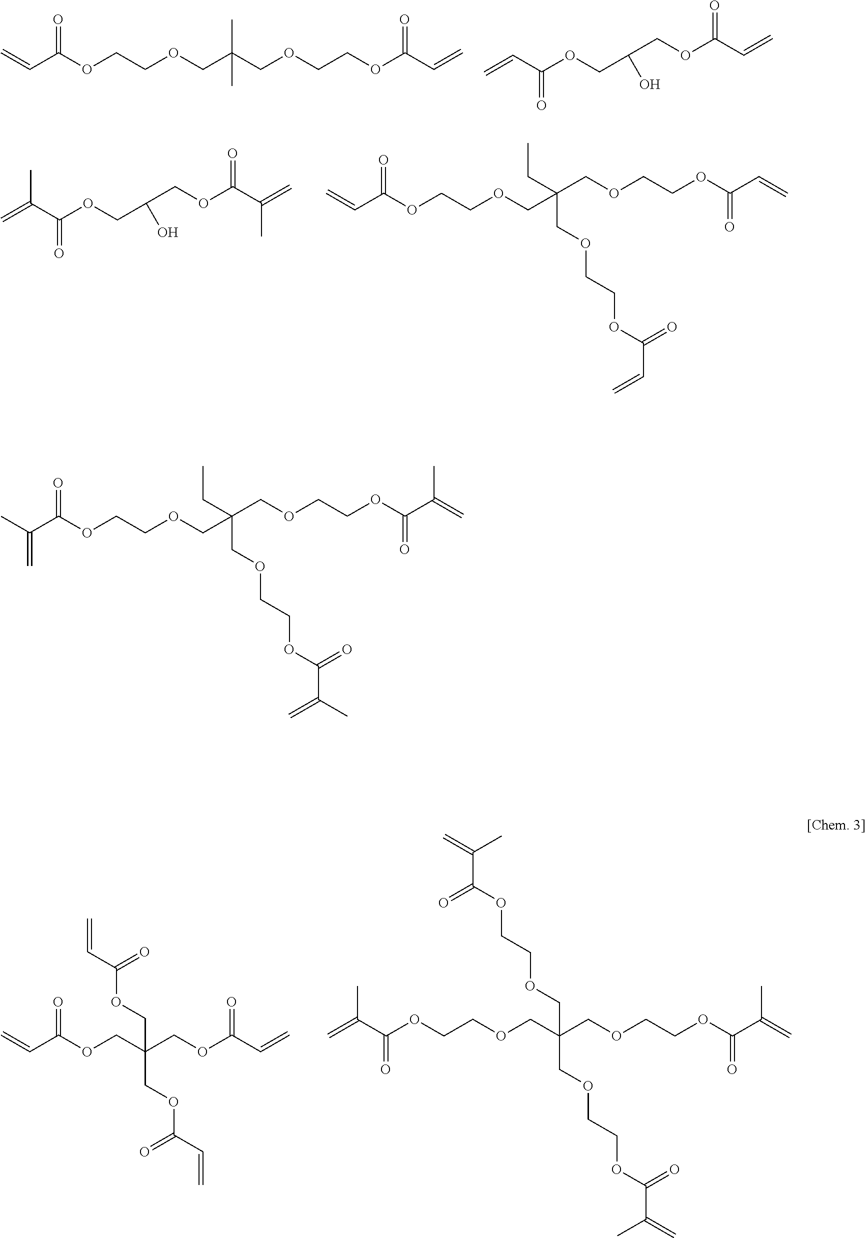

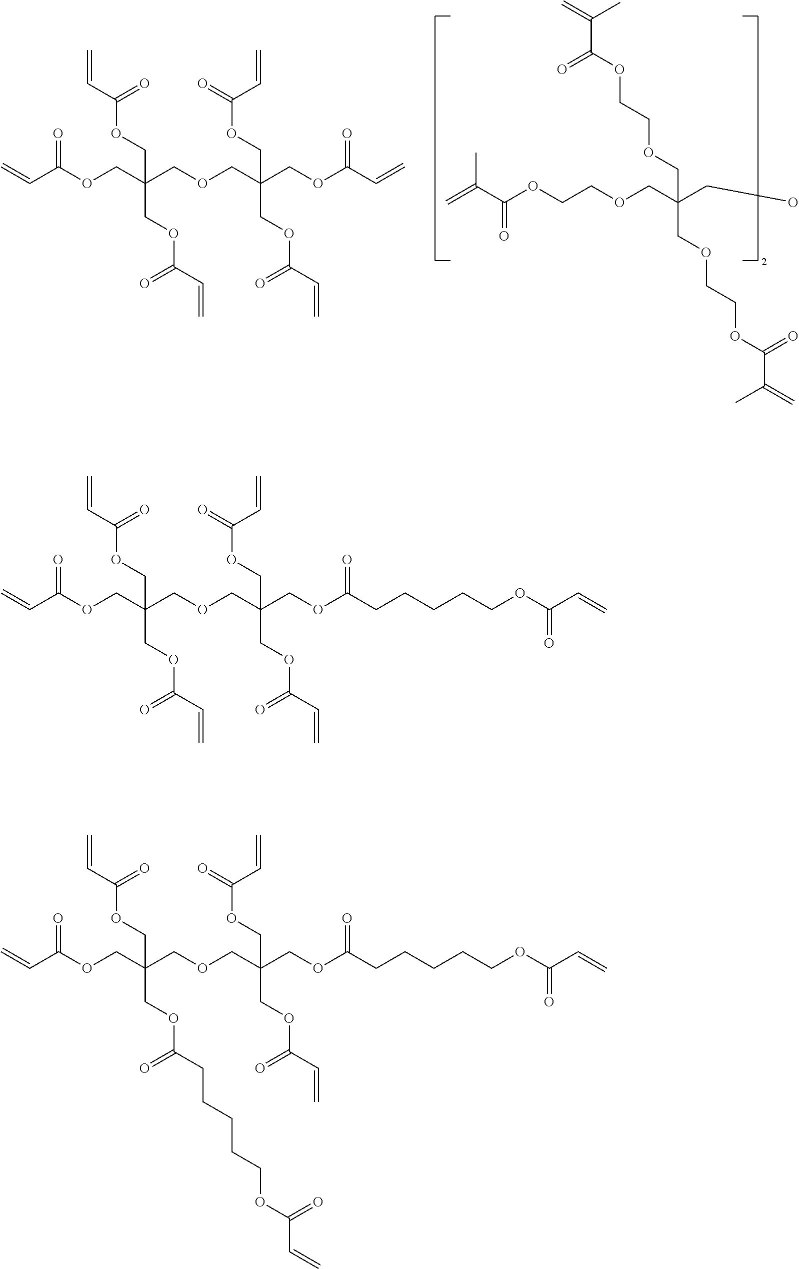

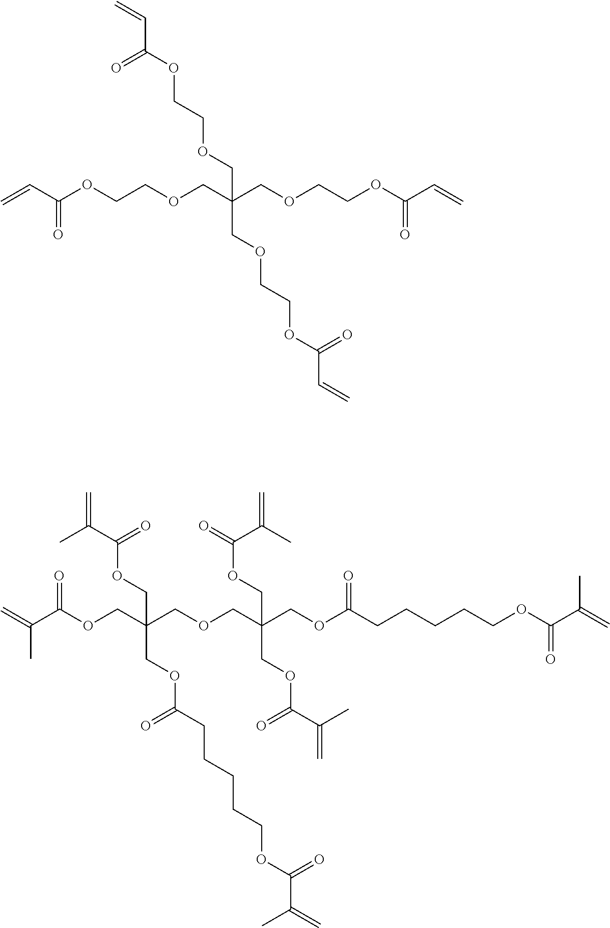

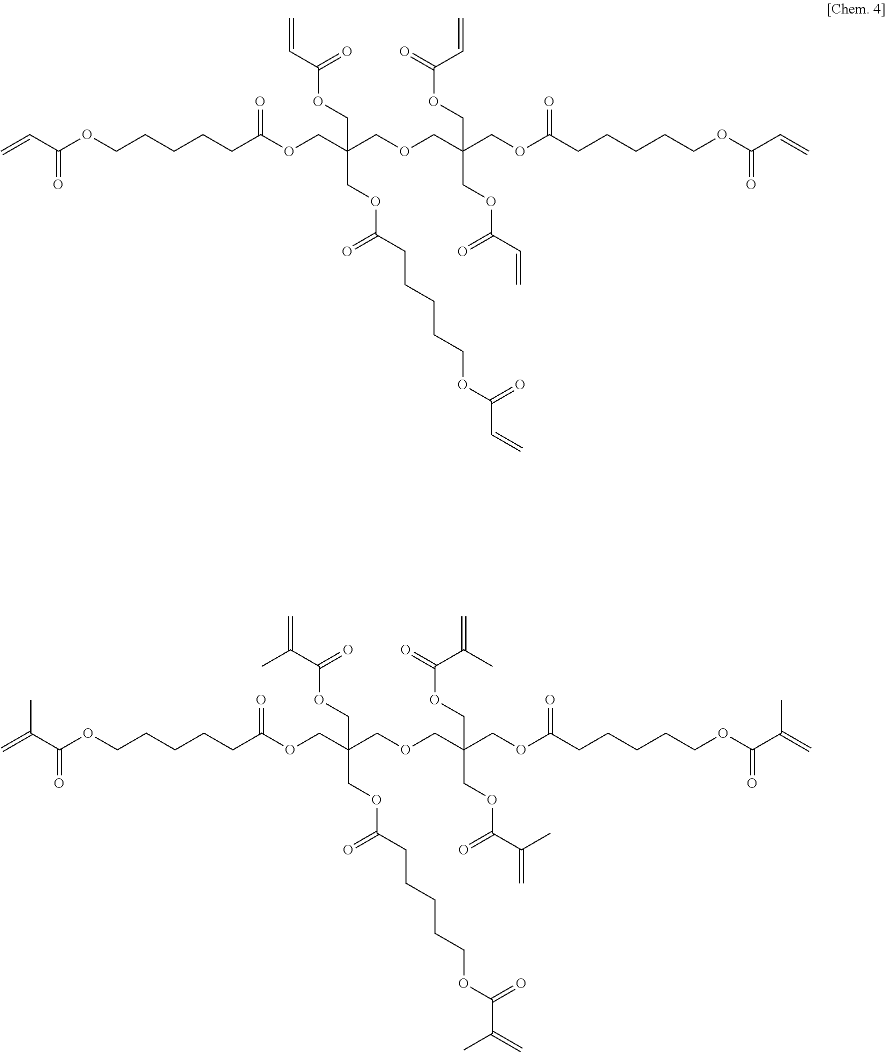

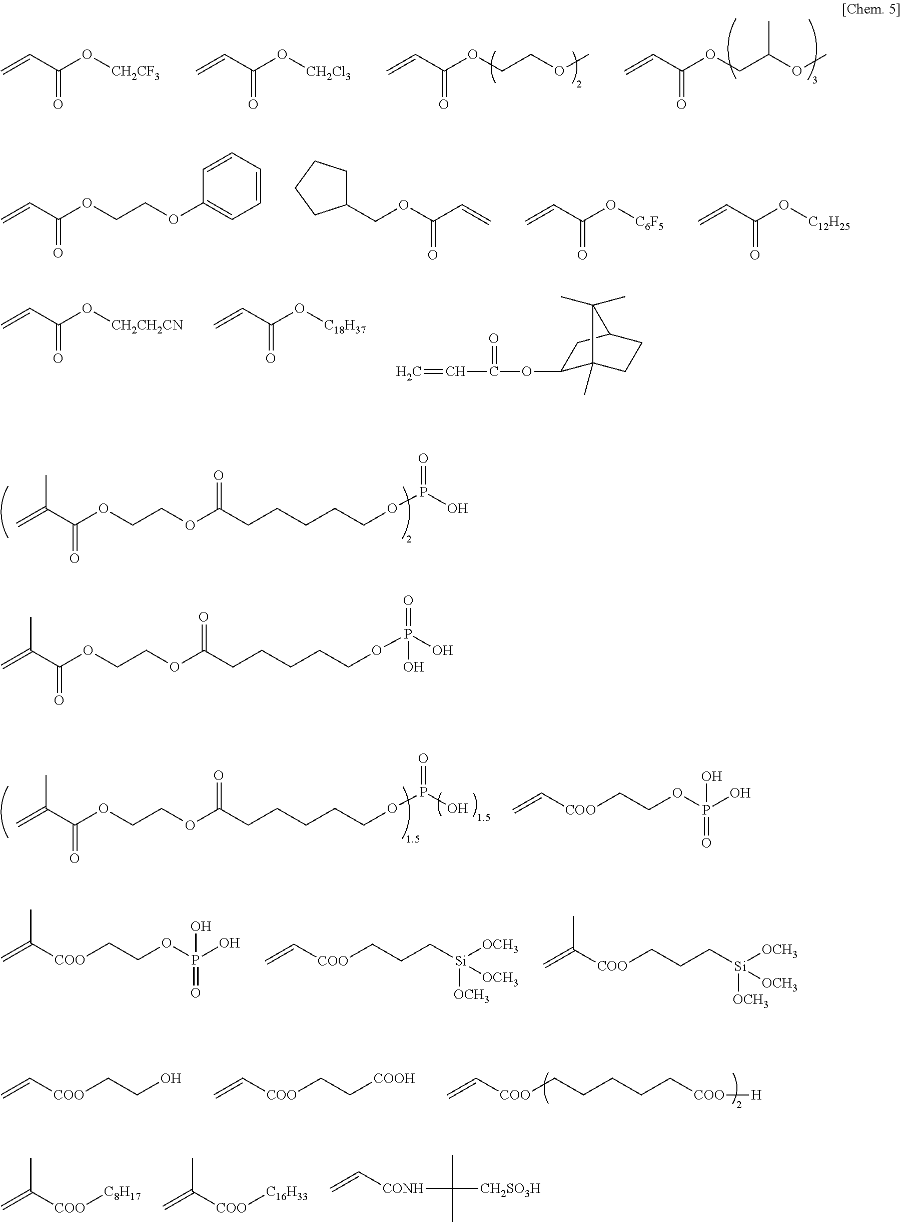

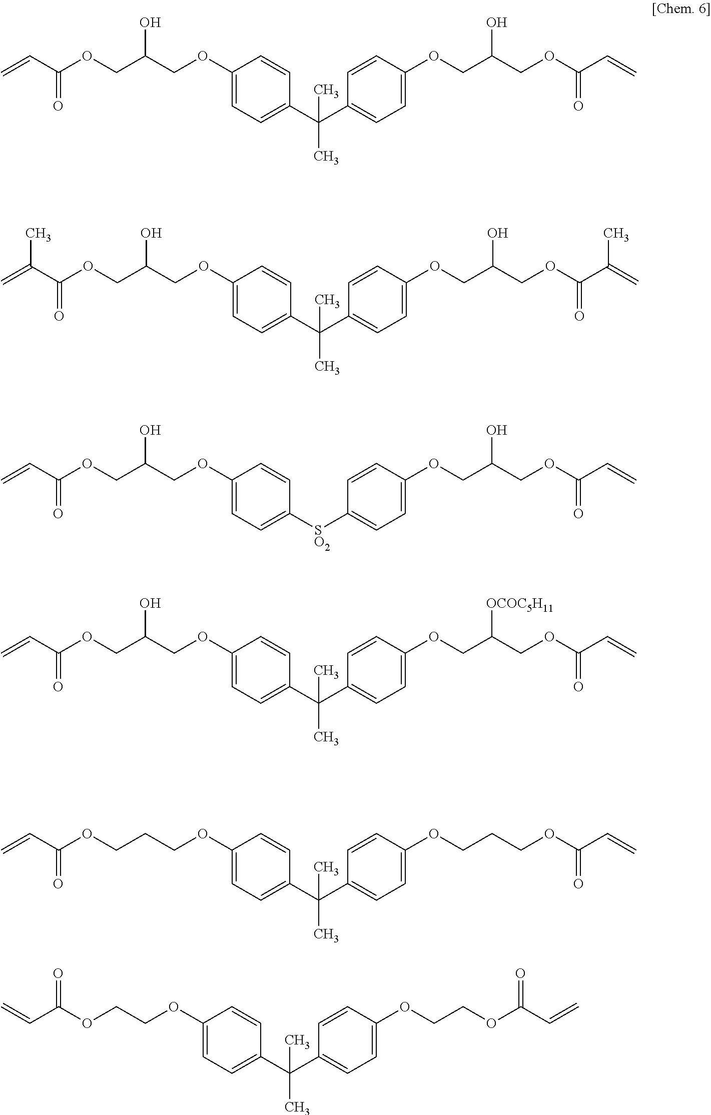

(Polymerization Initiator)

In a case in which the organic layer in the invention is produced by coating and curing a polymerizable composition including the polymerizable compound, the polymerizable composition may include a polymerization initiator. In a case in which the polymerization initiator is used, the content of the polymerization initiator is preferably 0.1 mol % or more of the total amount of the polymerizable compound, and more preferably 0.5 mol % to 2 mol %. Preferable examples of the polymerization initiator include the polymerization initiators described in paragraph [0057] in JP2010-089502A.

(The Method for Forming the Organic Layer)

The method for forming the organic layer is not particularly determined, but is preferably the method described in paragraphs [0058] and [0059] of JP2010-089502A.

The organic layer in the invention is preferably flat and has a high film hardness.

The content ratio of the polymerizable compound that configures the organic layer is preferably 85% or more, more preferably 88% or more, still more preferably 90% or more, and particularly preferably 92% or more. Here, the content ratio refers to a ratio of reacted polymerizable groups to all polymerizable groups (for example, acryloyl groups and methacryloyl groups) in the polymerizable composition. The content ratio can be quantified using an infrared ray absorption method.

The film thickness of the organic layer is not particularly limited; however, when the film thickness is too thin, it becomes difficult to make the film thickness uniform, and, when the film thickness is too thick, cracking occurs due to an external force such that the barrier property degrades. From such a viewpoint, the thickness of at least one of the first organic layer and the second organic layer is preferably 0.1 μm to 10 μm.

In addition, the organic layer is preferably flat as described above. The flatness of the organic layer is preferably less than 1 nm in terms of the average roughness (Ra value) of a 1 μm×1 μm area, and more preferably less than 0.5 nm. The surface of the organic layer needs to be free of foreign substances, such as particles, and protrusions. Therefore, the organic layer is preferably formed in a clean room. The cleanliness class is preferably a class 10000 or less, and is more preferably a class 1000 or less.

The hardness of the organic layer is preferably higher. It has been already known that, when the hardness of the organic layer is high, the inorganic layer is formed to be flat, and consequently, the barrier performance improves. The hardness of the organic layer can be expressed by a nano-indentation method-based micro-hardness. The micro-hardness of the organic layer is preferably 100 N/mm or more, and more preferably 150 N/mm or more.

(The Inorganic Layer)

The inorganic layer is generally a layer having a thin film, which is made of a metal compound. The inorganic layer may be formed using any method as long as a target film thickness can be formed. Examples thereof include physical vapor deposition (PVD), such as a deposition method, a sputtering method and an ion plating method, a variety of chemical vapor deposition (CVD), and liquid-phase growing methods, such as plating or a sol-gel method. Components included in the inorganic layer are not particularly limited, and examples thereof include metallic oxides, metallic nitrides, metallic carbides, metallic nitride oxides and metallic carbide oxides. More specific examples include oxides, nitrides, carbides, nitride oxides, carbide oxides and the like including one or more metals selected from Si, Al, In, Sn, Zn, Ti, Cu, Ce and Ta. Among the above, oxides, nitrides or nitride oxides of a metal selected from Si, Al, In, Sn, Zn and Ti are preferable, and oxides, nitrides or nitride oxides of Si or Al are particularly preferable. The above components may contain other elements as secondary components.

The flatness of the inorganic layer formed using the invention is preferably less than 1 nm in terms of the average roughness (Ra value) of a 1 μm×1 μm area, and more preferably less than 0.5 nm. The inorganic layer is preferably formed in a clean room. The cleanliness class is preferably a class 10000 or less, and is more preferably a class 1000 or less.

The thickness of the inorganic layer is not particularly limited, is generally in a range of 5 nm to 500 nm per layer, and preferably 10 nm to 200 nm. The inorganic layer may have a laminate structure made up of a plurality of sub layers. In this case, the respective sub layers may have the same composition or different compositions. In addition, the inorganic layer may be a layer in which the interface with the organic layer is not evident and the composition continuously changes in the film thickness direction as disclosed in the specification of US2004/46497A.

(The Lamination of the Organic Layer and the Inorganic Layer)

The organic layer and the inorganic layer can be laminated by sequentially and repeatedly manufacturing the organic layer and the inorganic layer according to a desired layer structure. In a case in which the inorganic layer is formed using a vacuum film manufacturing method, such as a sputtering method, a vacuum deposition method, an ion plating method or a plasma CVD method, the organic layer is also preferably formed using the vacuum film manufacturing method, such as a flash deposition method. While manufacturing the barrier layer, the organic layer and the inorganic layer are particularly preferably laminated in vacuum of 1000 Pa or less at all times without returning to the atmospheric pressure in the middle. The pressure is preferably 100 Pa, more preferably 50 Pa or less, and still more preferably 20 Pa or less.

The Adhesion Layer

In the invention, an adhesion layer can be provided for the purpose of any one of attaching the resin film and the gas barrier film (particularly, the barrier layer), attaching the resin film and the oxygen-absorbing resin layer, and attaching the oxygen-absorbing resin layer and the gas barrier film.

An adhesive included in the adhesion layer is also exemplified by an epoxy resin-based adhesive, a polyurethane-based adhesive, a vinyl ethylene acetate-based adhesive, an acrylic resin-based adhesive and the like. In addition, the adhesion layer may include other components, but the content thereof is preferably 1 mass % or less of the total.

The thickness of the adhesion layer is preferably 0.1 μm to 50 μm, and more preferably 1 μm to 30 μm.

Oxygen-Absorbing Resin Layer

In the invention, an oxygen-absorbing resin layer may be provided between the resin film and the gas barrier film, and the like. The oxygen-absorbing resin layer is exemplified by a resin layer including as the main component polyvinyl alcohol, ethylene-vinyl alcohol copolymer or the like, and, in general, the above resins account for 95 mass % or more of the total.

In addition, a synthetic resin layer, in which an oxygen-absorbing substance is dispersed, is also preferable. Examples of the oxygen-absorbing substance include a variety of well-known oxygen-absorbing substances, such as metallic substances, such as iron, zinc, ferrous oxide and sodium chloride-iron, sulfites, such as sodium acid sulfite and sodium sulfite; organic substances, such as pyrogallol and ascorbic acid; and the like, and iron or sodium sulfite is more preferably since the safety or stability is guaranteed. In addition, the sodium sulfite is advantageous that the transparency of the infusion solution bag can be maintained.

Regarding the amount of the oxygen-absorbing substance dispersed in the synthetic resin, the optimal amount can be appropriately determined depending on the type of the oxygen-absorbing substance being used and the oxygen-absorbing performance of the oxygen-absorbing substance, and, in general, approximately 1 mass % to 90 mass % of the oxygen-absorbing substance may be incorporated into the oxygen-absorbing resin layer. The optical amount can be selected from the above range.

An oxygen-permeable resin is preferable as the synthetic resin that configures the oxygen-absorbing resin layer. Particularly, polyolefins, such as polyethylene, polypropylene, ionomers and maleic acid anhydride-denatured polyethylene, are advantageous in terms of flexibility, moldability, affinity to the resins that configure other layers, and the like.

The thickness of the oxygen-absorbing resin layer is preferably 1 μm to 50 μm, and more preferably 2 μm to 20 μm.

The infusion solution bag used in the invention may be a single infusion solution bag, in which the number of the bag is one, or a duplex infusion solution bag, in which the number of bags is two or more. The duplex infusion solution bag is exemplified by a duplex bag made up of, for example, a powder accommodating chamber and a liquid accommodating chamber divided using a partition that can be easily separated from the powder accommodating chamber. In this case, immediately before use, the partition is separated, powder and liquid are mixed, and a solution is infused from the liquid discharging opening. In this case, the infusion solution bag of the invention is preferably used for the powder accommodating chamber.

A medicine that is accommodated in the infusion solution bag of the invention is exemplified by liquids, which are administered beneath skin, into a blood vessel, an abdominal cavity and the like through intravenous drip or the like. In the case of the duplex bag, the liquids are exemplified by powder-form medicines and liquids, such as a normal saline solution. The powder medicines are exemplified by nutritional supplement, such as vitamins or amino acids; antibiotics; antifungal agents; and the like.

In the invention, the laminate of the layer provided on the outside of the above resin film bag (exterior film) can be also used as an exterior film of other containers. In addition, the exterior film of the invention may be provided at the liquid discharging opening of the duplex infusion solution bag.

The total thickness of the layers provided on the outside of the infusion solution bag of the invention, that is, the thickness of the exterior film of the invention is preferably set to 20 μm to 200 μm, and more preferably set to 25 μm to 70 μm. The thin thickness of the exterior film as described above enables the more effective suppression of the intrusion of water vapor or oxygen from the side surface. Further, it is needless to say the purport is that the layers provided on the outside of the infusion solution bag include the plastic film and the like.

The infusion solution bag and exterior film of the invention are preferably set to 0.1 cc/m²/day/atm or less in the oxygen permeation under a temperature of 40° C., 1 atmospheric pressure and a relative humidity of 90%, and, furthermore, more preferably set to 0.01 cc/m²/day/atm or less.

In addition, the infusion solution bag and exterior film of the invention are preferably set to 0.01 g/m²/day or less in the water vapor permeability under a temperature of 40° C., 1 atmospheric pressure and a relative humidity of 90%, and, furthermore, more preferably set to 0.001 g/m²/day or less.

Furthermore, the infusion solution bag and exterior film of the invention preferably satisfy both the oxygen permeability and the water vapor permeability.

The infusion solution bag of the invention is preferably transparent in the surface provided with the barrier layer. That is, in a case in which the resin film on the side provided with the barrier layer is transparent and the barrier layer is laminated on the resin film through other configuration layers (for example, the adhesion layer, the oxygen-absorbing resin layer, and the like), the other layers are also preferably transparent. Furthermore, in a case in which other configuration layers (for example, the plastic film, the protective layer, the hard coat layer and the like) are laminated on the surface on the opposite side to the surface of the barrier layer, which faces the resin film, the other configuration layers are also preferably transparent. Thereby, the contents accommodated in the infusion solution bag can be easily observed visually from the outside.

Additionally, it is possible to reference the techniques described in JP2003-230618A and JP1998-201818 (JP-H10-201818A) with the scope of the purport of the invention.

### EXAMPLES

Hereinafter, the invention will be described more specifically using examples. The materials, used amounts, fractions, treatment contents, treatment order and the like described in the following examples can be appropriately changed within the scope of the purport of the invention. Therefore, the scope of the invention is not limited to specific examples described below.

### A Manufacturing Example

### The Production of a Gas Barrier Film B1

A barrier layer was formed on one surface side of a polyethylene terephthalate film (PET film, manufactured by Toray Industries, Inc., product name: LUMIRROR, thickness: 25 μm) in the following order and evaluated.

Trimethylolpropane triacrylate (TMPTA, manufactured by Daicel-Cytec Company Ltd., 14.1 g), acrylate having an phosphoester group (manufactured by Nippon Kayaku Co., Ltd., KAYAMER series, PM-21, 1.0 g), KBM-5103 (manufactured by Shin-Etsu Chemical Co., Ltd., 3.5 g) as a silane coupling agent and a photopolymerization initiator (manufactured by Lamberti S.p.A., ESACURE KTO 46, 1.4 g) were prepared, and the above components were dissolved in 180 g of methyl ethyl ketone, thereby producing a coating fluid. The coating fluid was coated on the flat surface of the PET film using a wire bar. After the coating fluid was dried at room temperature for 2 hours, the organic layer was cured by irradiating ultraviolet rays of a high-pressure mercury lamp (at an integrated irradiance level of 2 J/cm²) in a chamber, in which the concentration of oxygen was set to 0.1% using a nitrogen substitution method. The thickness of the organic layer was 1 μm.

Next, an inorganic layer (silicon nitride layer) was formed on the surface of the organic layer using a CVD apparatus. As raw material gases, silane gas (flow rate of 160 sccm), ammonia gas (flow rate of 370 sccm), hydrogen gas (flow rate of 590 sccm) and nitrogen gas (flow rate of 240 sccm) were used. A high-frequency power supply at a frequency of 13.56 MHz was used as a power supply. The film manufacturing pressure was 40 Pa, and the peak film thickness was 50 nm. The inorganic layer was laminated on the surface of the organic layer in the above manner.

Furthermore, additional organic layer was laminated on the surface of the inorganic layer in the same manner as the method for forming the organic layer.

### The Production of a Gas Barrier Film B2

A barrier layer was formed on one surface side of a polyethylene terephthalate film (PET film, manufactured by Toray Industries, Inc., product name: LUMIRROR, thickness: 25 μm) in the following order and evaluated.

NK oligo EA-1020 (manufactured by Shin-Nakamura Chemical Co., Ltd., 2.8 g), NK ester A-BPE-4 (manufactured by Shin-Nakamura Chemical Co., Ltd., 6.0 g), acrylate having an phosphoester group (manufactured by Nippon Kayaku Co., Ltd., KAYAMER series, PM-21, 0.5 g) and a photopolymerization initiator (manufactured by Lambeth S.p.A., ESACURE KTO 46, 0.7 g) were prepared, and the above components were dissolved in 190 g of methyl ethyl ketone, thereby producing a coating fluid. The coating fluid was coated on the flat surface of the PET film using a wire bar. After the coating fluid was dried at room temperature for 2 hours, the organic layer was cured by irradiating ultraviolet rays of a high-pressure mercury lamp (at an integrated irradiance level of 2 J/cm²) in a chamber, in which the concentration of oxygen was set to 0.1% using a nitrogen substitution method. The thickness of the organic layer was 1 μm.

Next, a film of Al₂O₃ was manufactured using a vacuum sputtering method (reactive sputtering method). Aluminum was used as the target, argon was used as the discharge gas, and oxygen was used as the reactive gas. An inorganic layer was laminated under a film-manufacturing pressure of 0.1 Pa and the film thickness of the inorganic layer was 60 nm.

Furthermore, additional organic layer was laminated on the surface of the inorganic layer in the same manner as the method for forming the organic layer.

### The Production of a Gas Barrier Film B3

A film of SiO₂ was manufactured using a vacuum sputtering method (reactive sputtering method) on one surface side of a polyethylene terephthalate film (PET film, manufactured by Toray Industries, Inc., product name: LUMIRROR, thickness: 25 μm), in this way, an inorganic layer having a film thickness of 100 nm was laminated.

### The Production of a Gas Barrier Film B4

A film of Al₂O₃, which was used in the gas barrier film B2, was manufactured using a vacuum sputtering method (reactive sputtering method) on one surface side of a polyethylene terephthalate film (PET film, manufactured by Toray Industries, Inc., product name: LUMIRROR, thickness: 25 μm), in this way, an inorganic layer having a film thickness of 60 nm was laminated.

### The Production of a Gas Barrier Film B5

A gas barrier film B5 was produced in the same manner as in the production of the gas barrier film B2 except that the organic layer was not formed on the surface of the Al₂O₃ inorganic layer in the production of the gas barrier film B2.

A polystyrene bag was used as the bag made of the resin film.

A low-density polyethylene film (manufactured by Mitsui Chemicals, Inc., thickness: 20 μm) was used as the resin film.

Adhesion Layer

The following adhesives were used.
A1: an epoxy resin-based adhesive
A2: a polyurethane-based adhesive

Oxygen-Absorbing Resin Layer

An ethylene-vinyl alcohol copolymer film (manufactured by Kuraray Co., Ltd., thickness: 12 μam) was used.

### Experiment Example 1

The gas barrier film, the resin film and the like were attached respectively using the adhesive so as to form layer configurations described below, thereby obtaining exterior films 1 to 16. The thickness of the adhesion layer was set to 3 μm. The resin film side of the obtained exterior film and the bag made of the resin film were fused using the heat sealing method, and infusion solution bags having the following layer configurations were produced.
L1: PET/organic layer/inorganic layer/organic layer/adhesion layer/oxygen-absorbing resin layer/adhesion layer/resin film
L1′: PET/inorganic layer/adhesion layer/oxygen-absorbing resin layer/adhesion layer/resin film
L1″: PET/organic layer/inorganic layer/adhesion layer/oxygen-absorbing resin layer/adhesion layer/resin film
L2: PET/organic layer/inorganic layer/organic layer/adhesion layer/resin film
L2′: PET/inorganic layer/adhesion layer/resin film
L2″: PET/organic layer/inorganic layer/adhesion layer/resin film

TABLE 1

| | Specimen No. | | | | | | | |
|---|---|---|---|---|---|---|---|---|
| | 1 | 2 | 3 | 4 | 5 | 6 | 7 | 8 |
| | Examples | | | | | | | |
| Barrier film | B1 | B2 | B1 | B2 | B1 | B2 | B1 | B2 |
| Adhesion | A1 | A1 | A2 | A2 | A1 | A1 | A2 | A2 |
| layer | | | | | | | | |
| Exterior film | L1 | L1 | L1 | L1 | L2 | L2 | L2 | L2 |
| configuration | | | | | | | | |
| Exterior film | 62 | 62 | 62 | 62 | 50 | 50 | 50 | 50 |
| thickness | | | | | | | | |

TABLE 2

| | Specimen No. | | | | | | | |
|---|---|---|---|---|---|---|---|---|
| | 9 | 10 | 11 | 12 | 13 | 14 | 15 | 16 |
| | Comparative examples | | | | | | | |
| Barrier film | B3 | B3 | B3 | B3 | B4 | B4 | B5 | B5 |
| Adhesion | A1 | A2 | A1 | A2 | A1 | A1 | A1 | A1 |
| layer | | | | | | | | |
| Exterior film | L1′ | L1′ | L2′ | L2′ | L1′ | L2′ | L1″ | L2″ |
| configuration | | | | | | | | |
| Exterior film | 60 | 60 | 48 | 48 | 60 | 48 | 61 | 49 |
| thickness | | | | | | | | |

In the above tables, the thickness of the exterior film indicates the total thickness (unit: μm) of the gas barrier film and the like, which were attached to the outside of the infusion solution bag.

<The Measurement of Water Vapor Permeability Using a Calcium Method>

The water vapor permeability was measured on the exterior film side of the obtained infusion solution bag using a calcium method. That is, the water vapor permeability (g/m²/day) was measured using the method described in pages 1435 to 1438 of SID Conference Record of the International Display Research Conference by G NISATO, P. C. P. BOUTEN and P. J. SLIKKERVEER. At this time, the temperature was set to 40° C., and the relative humidity was set to 90%. The results were described in the following table.

<The Measurement of the Oxygen Permeability>

The oxygen permeability was measured on the exterior film side of the obtained infusion solution bag using an oxygen MOCO method.

<The Storage Stability of a Medicine>

As a medicine, cefazolin sodium (manufactured by Otsuka Pharmaceutical Factory, Inc.) was encapsulated in the obtained infusion solution bag, stored for 6 months under conditions of 40° C. and a relative humidity of 75%, and a change in the tone was evaluated.

The evaluation was carried out using the following standards.
A: There was no change in the tone.
B: There was a partial and slight change in the tone.
C: The medicine turned into light yellow.
D: The medicine turned into yellow.

The results are described in the following table.

TABLE 3

| | Water vapor | Oxygen | Storage |
|---|---|---|---|
| Specimen | permeability | permeability | stability |
| No. | (g/m²/day) | (cc/m²/day/atm) | of medicine |
| 1 | 0.001 | 0.002 | B |
| 2 | 0.001 | 0.002 | B |
| 3 | 0.001 | 0.002 | B |
| 4 | 0.001 | 0.002 | B |
| 5 | 0.0005 | 0.002 | A |
| 6 | 0.0005 | 0.002 | A |
| 7 | 0.0005 | 0.002 | A |
| 8 | 0.0005 | 0.002 | A |
| 9 | 0.1 | 0.1 | C |
| 10 | 0.1 | 0.1 | C |
| 11 | 0.1 | 1.0 | D |
| 12 | 0.1 | 1.0 | D |
| 13 | 0.05 | 0.1 | C |
| 14 | 0.05 | 0.1 | C |
| 15 | 0.01 | 0.1 | C |
| 16 | 0.01 | 0.1 | C |

### Experiment Example 2

The exterior films 1 to 16 of the above Experiment example 1 were respectively laminated and adhered to the container main body turning the resin film inward, so as to fully cover one surface of the top chamber of a polyethylene bag, which have a partition structure consisting of a sealant with an easy peel open property and has two chambers. Then, the circumferential edge portions of the exterior films 1 to 16 were fused to the container main body using the heat sealing method, thereby manufacturing infusion solution bags.

<The Storage Stability of a Medicine>

As a medicine, cefazolin sodium (manufactured by Otsuka Pharmaceutical Factory, Inc.) was encapsulated in the top chamber of the obtained infusion solution bag, stored for 6 months under conditions of 40° C. and a relative humidity of 75%, and a change in the tone was evaluated.

The evaluation was carried out using the following standards.
A: There was no change in the tone.
B: There was a partial and slight change in the tone.
C: The medicine turned into light yellow.
D: The medicine turned into yellow.

The results are described in the following table.

TABLE 4

| Specimen No. | Storage stability of medicine |
|---|---|
| 1 | B |
| 2 | B |
| 3 | B |
| 4 | B |
| 5 | A |
| 6 | A |
| 7 | A |
| 8 | A |
| 9 | C |
| 10 | C |
| 11 | D |
| 12 | D |
| 13 | C |
| 14 | C |
| 15 | C |
| 16 | C |

What is claimed is:

1. An infusion solution bag comprising:
a bag made of a resin film including polyethylene and/or polypropylene; and
a barrier layer provided on at least one surface of the bag,
wherein the barrier layer has a structure in which a first organic layer, an inorganic layer and a second organic layer mutually adjoin in this order.

2. The infusion solution bag according to claim 1,
wherein a gas barrier film is attached to an outside of the bag made of the resin film through at least an adhesion layer, the gas barrier film has a plastic film and the barrier layer, the barrier layer is provided closer to the bag made of the resin film than to the plastic film.

3. The infusion solution bag according to claim 2,
wherein a resin film including polyethylene and/or polypropylene and the barrier layer are provided in this order on the outside of the bag made of the resin film.

4. The infusion solution bag according to claim 3,
wherein the bag made of the resin film is a bag formed by joining two resin films including polyethylene and/or polypropylene or a bag formed by folding and joining a resin film including polyethylene and/or polypropylene.

5. The infusion solution bag according to claim 4,
wherein the barrier layers are provided on both surfaces of the bag made of the resin film.

6. The infusion solution bag according to claim 3,
wherein the first organic layer and the second organic layer are formed of the same material.

7. The infusion solution bag according to claim 3,
wherein at least one of the first organic layer and the second organic layer is a layer formed by curing a polymerizable composition including a (meth)acrylate-based compound.

8. The infusion solution bag according to claim 3,
wherein a thickness of at least one of the first organic layer and the second organic layer is 0.1 μm to 10 μm

9. The infusion solution bag according to claim 3,
wherein a total thickness of layers provided on an outside of the resin bag is 20 μm to 200 μm.

10. The infusion solution bag according to claim 3,
wherein a surface of the infusion solution bag, on which the barrier layer is provided, is transparent.

11. The infusion solution bag according to claim 3,
wherein an oxygen-absorbing resin layer is not included between the outside of the bag made of the resin film and the barrier layer.

12. The infusion solution bag according to claim 3,
wherein the resin film including polyethylene and/or polypropylene, the adhesion layer and the gas barrier film are provided in this order on the outside of the bag made of the resin film in a mutually adjoining fashion.

13. The infusion solution bag according to claim 3,
wherein the oxygen-absorbing layer is included between the outside of the bag made of the resin film and the barrier layer.

14. The infusion solution bag according to claim 13,
wherein the resin layer including polyethylene and/or polypropylene, the adhesion layer, the oxygen-absorbing resin layer, the adhesion layer and the gas barrier film are provided in this order on the outside of the bag made of the resin film in a mutually adjoining fashion.

15. The infusion solution bag according to claim 3,
wherein the adhesion layer includes an epoxy resin-based adhesive.

16. The infusion solution bag according to claim 3,
wherein the adhesion layer includes a polyurethane-based adhesive.

17. The infusion solution bag according to claim 3 which is a duplex infusion solution bag.

18. An exterior film comprising:
a resin film including polyethylene and/or polypropylene;
an oxygen-absorbing resin layer; and
a barrier layer in this order,
wherein the barrier layer has a structure in which a first organic layer, an inorganic layer and a second organic layer mutually adjoin in this order.

19. An exterior film comprising:
a resin film including polyethylene and/or polypropylene;
an oxygen-absorbing resin layer provided on the resin film through an adhesion layer; and
a barrier layer provided on the oxygen-absorbing resin layer through an adhesion layer in this order,
wherein the barrier layer has a structure in which a first organic layer, an inorganic layer and a second organic layer mutually adjoin in this order.

20. An exterior film comprising:
a resin film including polyethylene and/or polypropylene;
an adhesion layer; and
a barrier layer in this order,
wherein the barrier layer has a structure in which a first organic layer, an inorganic layer and a second organic layer mutually adjoin in this order.

21. A method for manufacturing the infusion solution bag according to claim 3, comprising:
attaching the resin film side of a laminate having the resin film including polyethylene and/or polypropylene and the gas barrier film to the bag made of a resin film using a thermal sealing method.
